(19) United States
(12) Patent Application Publication
(10) Pub. No.: US 2026/0361758 A1
(43) Pub. Date: Nov. 12, 2026

(54) SURGE PROTECTION FOR DETECTED EMAIL OVERLOADS

(71) Applicant: Material Security Inc., San Francisco, CA (US)

(72) Inventors: Sean Joseph Fellows, Denver, CO (US); Caroline Irene Pierce, Somerville, MA (US); Alexander Leonardo Visbal, Ann Arbor, MI (US); Mary Amer, Denver, CO (US); Michael Thaddeus Moran, Brooklyn, NY (US); Anqi Cong, Astoria, NY (US)

(21) Appl. No.: 19/669,745

(22) Filed: May 6, 2026

Related U.S. Application Data
(60) Provisional application No. 63/802,280, filed on May 8, 2025.
(60) Provisional application No. 63/805,865, filed on May 14, 2025.

(51) Int. Cl. H04L 9/40; H04L 51/212; H04L 51/42

(52) U.S. Cl. CPC H04L 63/1441; H04L 51/212; H04L 51/42

(57) ABSTRACT

A system monitors for incoming emails that may look legitimate but are from a malicious source. In response to detecting that an incoming email is targeting a user, the system increments a surge counter. In response to the surge counter meeting a threshold, the system determines whether each incoming email meets one or more legitimacy criteria associated with trust characteristics. In response to determining that a respective incoming email meets at least one legitimacy criteria, the system adds the respective incoming email to the user's inbox. In response to determining that the respective incoming email does not meet any legitimacy criteria, the system stores the email in a surge repository. The user or an administrator may view and interact with the surge repository via an interface and receive alerts about the status of a surge of emails targeting the user.

### CROSS REFERENCE TO RELATED APPLICATIONS

This application claims the benefit of U.S. Provisional Patent Application Ser. No. 63/802,280, filed May 8, 2025, and U.S. Provisional Patent Application Ser. No. 63/805,865, filed May 14, 2025, which are incorporated by reference herein in their entirety.

### BACKGROUND

The landscape of email communication has been significantly affected with the recent evolution of spam tactics. As techniques grow more sophisticated, so do the problems they present, often creating difficulties in distinguishing between legitimate and spam emails. One particularly vexing issue arises from inboxes being spammed with emails from genuine email addresses. For example, thousands or millions of viewers of a live broadcast may look up a speaker's email address and send them numerous emails in a short time frame from the broadcast time. The emails are legitimate in isolation because they come from real individuals'email addresses and are genuine outreach, and therefore would not be detected as spam or illegitimate by typical email blockers. This can rise to an overwhelming volume, effectively rendering the speaker's inbox unusable until the deluge of emails eventually subsides. In another example, an entity may flood a user's inbox by triggering a huge volume of apparently legitimate email (e.g., password reset requests) before emailing/calling the user while posing as an Information Technology (IT) administrator offering to help the user with the flood of emails. The entity may thus capitalize on the overwhelm to the user's inbox to try to acquire personal or otherwise sensitive information from the user.

A key distinction between traditional spam messages and email surges lies in the source of the messages. Spam messages are often automated batches of emails originating from a limited number of sources (e.g., botnets). Email surge messages, as described above, may originate from legitimate sending parties. While the sending parties may not be in communication with one another, their intent and content of messages contributing to the surge is substantially aligned. Existing spam filters in an email service or network-level protections against malicious events (e.g., distributed denial of service (DDoS) attacks) can block coordinated groups of bad actors, therefore stopping a high inflow of malicious content. However, an email surge event stemming from a macro group of senders having aligned interests (e.g., political affiliation) results in a pool of actors that may be several orders of magnitude greater than a typical source of a targeted attack. Furthermore, blocking content (e.g., using a firewall) during a malicious event may prevent the recovery of legitimate emails. Blocking a high volume of messages from legitimate sending parties in response to the email surge event can lead to a significant number of false positives. As such, non-malicious messages from legitimate senders are blocked instead of being flagged for review. This approach does not allow for the review or recovery of potentially important messages that were blocked in association with the surge event.

Current solutions for mitigating such unwelcome email surges usually involve the recipient needing to resort to a temporary change in their email address until the email overload ceases. Additionally, it inevitably leads to the painstakingly time-consuming process of manually sorting through the inbox to retrieve any other critical emails that arrived simultaneously with the email overflow. Notably, these solutions are usually reactive, implemented only after the surge of emails has already transpired. This approach merely mitigates the post-effect of the problem rather than proactively preventing it. Thus, existing solutions fall short of effectively preventing the onslaught of email surges from occurring in the first place.

### SUMMARY

Systems and methods are disclosed herein for providing surge protections in response to detections of email overloads. In an embodiment, incoming emails to a user's inbox are monitored for an influx of emails that have characteristics of targeting the user. A counter is incremented for each potentially illegitimate email that is received, and, responsive to the counter exceeding a threshold within a sliding time window, the emails are logically separated (e.g., stored in a separate repository or a different location within the user's inbox, labeled as a surge category, etc.), effectively quarantining the emails from the user's inbox. This prevents the emails from overwhelming the user's inbox but maintains the emails such that the user may review the emails later. Incoming emails that show characteristics of trustworthiness are allowed into the user's inbox during the surge, thus allowing the user to access those emails easily. In response to the counter being under the threshold within a second time window, incoming emails are allowed through to the user's inbox without the extra scrutiny of detecting characteristics of trust. A user can maintain the use of their inbox during an onslaught of malicious messages if the surge event is appropriately detected and incoming messages are filtered in a reasonable time frame. Messages from legitimate sending parties may be retained and reviewed with low latency. When an email overload is not detected, emails from legitimate sending parties can be considered in real-time and dealt with accordingly by the user.

The systems and methods disclosed herein are for providing surge protections from email overloads. In an embodiment, a security service monitors incoming emails to be stored in an inbox repository. The security service may determine whether each incoming email is targeting the user (e.g., meets one or more heuristics indicative of a spam email) and increment a surge counter whenever such an incoming email is detected. The security service monitors the surge counter relative to a threshold for a sliding range of time—that is, the security service looks to see whether the number of incoming emails received over a range of time has exceeded the threshold. In response to the surge counter meeting the threshold during the sliding range of time, the security service determines whether additional incoming emails meet one or more of a set of legitimacy criteria. In response to determining that a respective incoming email does not meet one or more of the set of legitimacy criteria, the security service stores the respective incoming email in a surge repository. In response to determining that a respective incoming email does meet at least one of the set of legitimacy criteria, the security service stores the respective email in the inbox repository.

The configuration of the heuristics and legitimacy criteria allow the system to maintain a high bar for whether to count an email as trustworthy compared to the methods used by traditional systems. This effectively causes the system to identify any email that is not clearly legitimate as spam (e.g., untrustworthy). The use of the surge counter balances against the strict view of legitimacy as the surge counter is incremented for untrustworthy emails but decremented over time, thus allowing the system to identify surges of untrustworthy emails rather than general spam.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

Figure (FIG.) 1 illustrates one embodiment of a system environment including infrastructure for a secure communications service to enforce security rules on files stored within a cloud-based content management system.

FIG. 2 is a block diagram of a secure communications service, in accordance with one or more embodiments.

FIGS. 3A-3B illustrate an exemplary user interface that display information about a surge of emails, in accordance with one or more embodiments.

FIG. 4 is a block diagram illustrating components of an example machine able to read instructions from a machine-readable medium and execute them in a processor (or controller), in accordance with one or more embodiments.

FIG. 5 is a flowchart of a method for determining whether to store an incoming email in a surge repository or an inbox repository, in accordance with one or more embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

FIG. 1 illustrates one embodiment of a system environment including infrastructure for a secure communications service to enforce security rules on files stored within a cloud-based content management system. As depicted in FIG. 1, environment 100 includes domain 110, network 120, secure communications service 130, and content management system 140. Domain 110 may be any environment having a plurality of users sharing a common set of security constraints. A typical domain may include users within a company sharing a domain name and sharing a team of administrators, such as an information technology team. Domain 110 includes user 111 and administrator 112. While these are recited in the singular, any number of users and administrators may be part of domain 110.

User 111 may be any user operating under the security policies provided by administrator 112. User 111 may include different users subject to different security policies (e.g., different teams within a domain may be subject to different security policies; users with certain titles may be subject to different security policies; etc.). User 111 may connect to domain 110 through any client device, such as a laptop, personal computer, smartphone, smart watch, or any other client device having a user interface capable of interfacing with domain 110. User 111 may have an email associated with domain 110 with emails stored at content management system 140.

Administrator 112 may be a person having credentials to take remedial action with respect to content within domain 110, such as files, electronic communications (e.g., instant messages, emails, text messages, and any other type of electronic communication whether or not taken through a third-party application such as Slack or Teams), which are all henceforth referred to as files for simplicity. Administrator 112 may set rules to automatically detect files and set automatic remedial actions to occur with respect to those files. Administrators themselves may have their associated files subject to rules for remediation (e.g., where there is a hierarchy in the administrators and more strict rules are applied with respect to content of administrators that are lower in the hierarchy; e.g., where security rules may apply uniformly regardless of user credentials; etc.).

Network 120 may be any network suitable for interfacing user 111 and administrator 112 to domain 110 (e.g., in scenarios where users are distributed, such as working remotely or across many office sites). Network 120 may be any network suitable for interfacing domain 110 to secure communications service 130 and/or content management system 140, and for interfacing secure communications service 130 to content management system 140. Network 120 may be any data communications channel, such as any combination of the Internet, Wi-Fi, short-range links, local area networks, and so on. Network tunneling may be used to connect any entity depicted in FIG. 1, such as virtual private network (VPN) or any other tunneling protocol.

Secure communications service 130 is a cloud service provider that provides tools to domain 110 for securing domain content stored on content management system 140. Content management system 140 is a cloud service offering secure content storage for content generated and/or stored by users of domain 110. Content management system 140 may offer permission settings for content from a domain. The permission settings may enable owners and/or authors of content to establish permissions for usage of the files. The permissions may be to access, edit, share, copy, credential permissions for other users, or perform any other function with respect to a given piece of content. Usage of content management system 140 to store files of domain 110 offers security risks. For example, private content that should not be shared outside of domain 110 may accidentally be credentialed with permissions for general public access or for access by one or more external parties. Secure communications service 130 provides tools that enable administrators of domain 110 to create rules that close security gaps in files that are stored outside of domain 110 in content management system 140. While only one content management system 140 is shown in environment 100, any number of different content management systems may be used and secure communications service 130 may generate and enforce rules across those different content management systems.

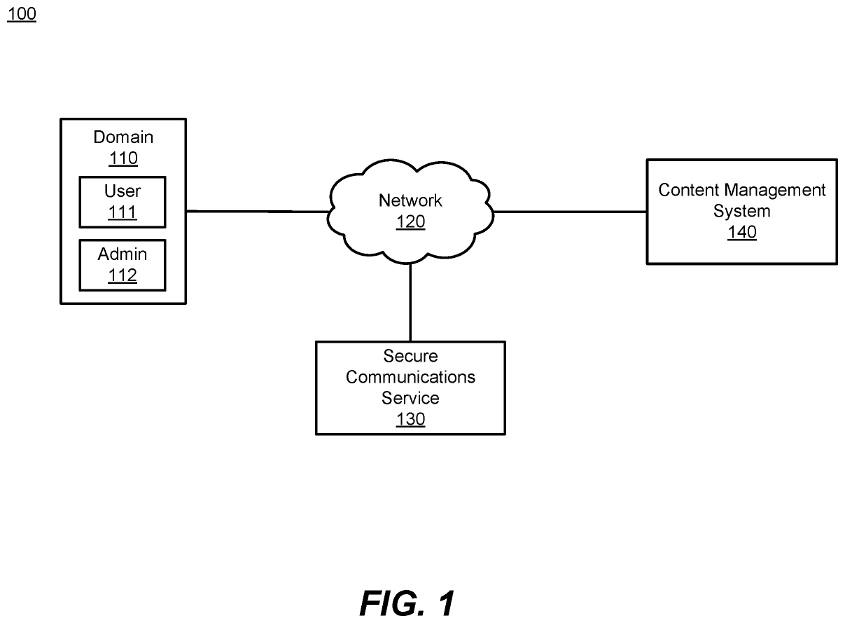

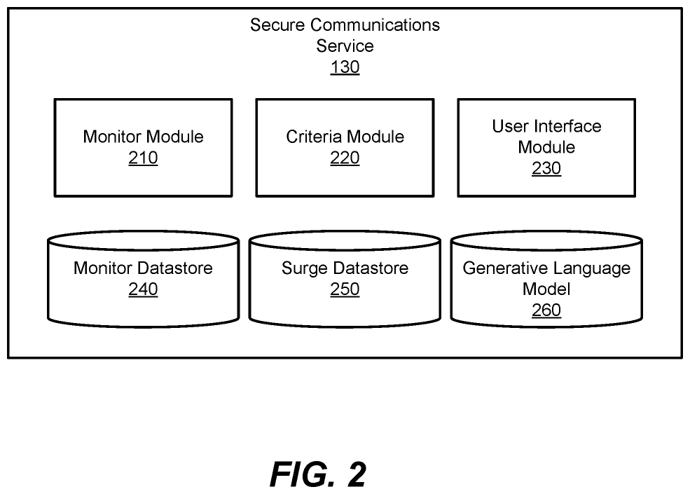

FIG. 2 is a block diagram of a secure communications service 130, in accordance with one or more embodiments. The secure communications service 130 includes monitor module 210, legitimacy criteria module 220, user interface module 230, monitor datastore 240, surge datastore 250, and generative language model 260. In some embodiments, additional or alternative components to those shown may be included in the secure communications service 130.

Monitor module 210 monitors incoming emails to content management system 140. Though described to herein in relation to emails, in some embodiments, the emails may be other incoming files to content management system 140. Further, in some embodiments, the emails may be stored within content management system 140, on-premises within domain 110, and/or within another secure content storage database. For example, monitor module 210 (or user interface module 230) may cause an application programming interface (API) to hook into domain 110 and monitor for emails being written to content management system 140 that originate from domain 110.

As emails are written, updated, or otherwise accessed or created for user 111, monitor module 210 determines whether each email meets one or more exclusion criteria. Exclusion criteria are characteristics of emails that are not likely part of a surge and also may be referred to as trust characteristics. Examples of exclusion criteria include a sender that user 111 subscribes to, an auto-reply email, a bounce-back email, and the like. Monitor module 210 may detect an incoming email with one or more exclusion criteria by comparing an identifier of the sender of the email to a list of identifiers associated with exclusion criteria. In some embodiments, monitor module 210 inputs the contents of the email to a generative language model configured to identify one or more exclusion criteria met by the email. Monitor module 210 may allow incoming emails with one or more exclusion criteria to be placed in user's 111 inbox repository without applying any heuristics to the emails. Monitor module 210 otherwise tags an email that does not meet any exclusion criteria as untrustworthy (e.g., not necessarily a legitimate email).

In some embodiments, monitor module 210 may determine whether any of the emails are specifically targeting user 111. In particular, monitor module 210 may apply a set of heuristics to each incoming email. In some embodiments, the set of heuristics are specific to user 111, such that user 111 or administrator 112 selected the heuristics for the set. Each heuristic in the set may be associated with one or more targeting characteristics seen in spam emails or a type of the email (e.g., personal, work-related, promotional, etc.). Targeting characteristics may include personalized details about user 111 (e.g., name, job title, other identifiable information), a spoofed domain (e.g., a domain that appears to be reputable or familiar to user 111 but may include slight modifications, such as common typos or switches of similar-looking characters), content conveying a sense of urgency or fear or otherwise prompting user 111 to act quickly, requests for personal or sensitive information, attachments or external links leading to malicious sites (e.g., those that capture sensitive information or install malware), poor grammar or spelling errors, and unsolicited requests from an account posing as part of domain 110, someone user 11 knows, or another reputable external entity. In some embodiments, the heuristics may be associated with one or more generative language models configured to receive an email as a prompt and output an indication of one or more targeting criteria met by the email. The heuristics may be stored in monitor datastore 240.

In response to detecting an incoming email that is untrustworthy, monitor module 210 determines one or more counters to associate the incoming email with. Monitor module 210 may maintain a surge counter for user 111 in monitor datastore 240. The surge counter represents a level of emails tagged as untrustworthy that were received in a respective sliding time range. The sliding time range associated with the surge counter may slide over time such that the length of time in the sliding time range remains the same, but the end of the sliding time range always ends at a current time. In some embodiments, the sliding time range may dynamically update based on an amount of incoming emails being received, such as by beginning the sliding time range at a time that a first incoming email was received. For example, monitor module 210 may select the first incoming email to begin the sliding time range at based on the first incoming email having been received more than a threshold amount of time from a previous incoming email (e.g., one hour after the previous incoming email). Monitor module 210 increments the surge counter by one for each untrustworthy email and stores an identifier of the incoming email, a timestamp of when the incoming email came in, and the amount the surge counter was incremented (e.g., by one) in response to tagging the email as untrustworthy in monitor datastore 240.

In some embodiments, monitor module 210 may additionally or alternatively increment the surge counter each time a heuristic is met. In some embodiments, monitor module 210 increments (e.g., adds to) the surge counter by an amount associated with each met heuristic, which may be stored in monitor datastore 240 or determined by the heuristic. For example, a heuristic that determines whether an email contains vulgar language may output a percentage representative of how much of the content of the email includes vulgar language. Monitor module 210 may determine that the heuristic was met so long as the output is more than zero and increment the surge counter by the percentage. In some embodiments, the amounts associated with the heuristics may be different from one another such monitor module 210 may increment the surge counter by a first amount for an email that meets a first heuristic and by a second amount for an email that meets a second heuristic. For each met heuristic, monitor module 210 stores an identifier of the email, a timestamp of when the email came in, and the amount the surge counter was incremented in response to the heuristic being met in association with the surge counter in monitor datastore 240.

In some embodiments, monitor module 210 stores one or more category counters for user 111 in monitor datastore 240. Each category counter may be associated with a set of heuristics and its own sliding time range. Monitor module 210 determines whether any heuristics met by an incoming email form a set associated with a category counter and increments the category counter based on the amounts associated with the heuristics in the set. For example, a first heuristic may determine whether the incoming email has a first targeting characteristic, and a second heuristic determine whether the incoming email has a second targeting characteristic. The first heuristic and second heuristic form a set of heuristics associated with a respective category counter, so monitor module 210 increments the respective category counter by both the amount associated with the first heuristic and the amount associated with the heuristic. For each set of heuristics met, monitor module 210 stores an identifier of the email, a timestamp of when the email came in, and the amount the category counter was incremented by in response to the set of heuristics being met in association with the category counter in monitor datastore 240.

Monitor module 210 updates the surge counter and category counters as time goes by to remove the influence of emails received outside of respective sliding time ranges. For example, monitor module 210 may detect when a timestamp of an identified email stored in relation to the surge counter is outside of the sliding time range associated with the surge counter. In response to detecting that the timestamp is outside of the sliding time range, monitor module 210 accesses the amount associated with the identifier of the email and the timestamp and decrements the surge counter by the amount. Similarly, monitor module 210 may detect when a timestamp of an identified email stored in relation to a category counter is outside of the sliding time range associated with the category counter. In response to detecting that the timestamp is outside of the sliding time range of the category counter, monitor module 210 accesses the amount(s) associated with the identifier of the email and the timestamp and decrements the category counter by the amount. Monitor module 210 may also remove the identifier, timestamp, and amount associated with the email from monitor datastore 240. In some embodiments, monitor module 210 resets the surge counter and each category counter to zero after a threshold amount of time has passed since the respective counter was incremented.

Criteria module 220 determines whether the surge counter meets a surge threshold. The surge threshold may be set by user 111 or administrator 112 and stored in monitor datastore 240 or surge datastore 250. In some embodiments, criteria module 220 dynamically adjusts the surge threshold associated with the user based on an average volume of emails received by user 111 over each day (or another time period). For example, criteria module 220 may decrease the surge threshold as user's 111 average volume of emails received decreases or increase the surge threshold as user's 111 average volume of emails received increases. Criteria module 220 also determines whether a category counter meets a respective category threshold, which may be set by user 111 or administrator 112.

In response to the surge threshold or a category threshold being met, criteria module 220 begins examining incoming emails to determine whether to allow a respective incoming email into user's 111 inbox repository or to store the respective incoming email in a separate surge repository. Criteria module 220 may create the surge repository for storing the incoming emails that are part of the surge (e.g., the emails being monitored by criteria module 220 in response to a threshold being met). Criteria module 220 may create the surge repository at surge datastore 250 or content management system 140. In some embodiments, criteria module 220 stores emails in a surge repository created for all surges, rather than a surge instance-specific surge repository. Criteria module 220 may also store the emails or identifiers of the emails that contributed to the surge or category threshold(s) in the surge repository.

Criteria module 220 may also take over incrementing the surge counter and any category counters from monitor module 210 in response to determining that the surge threshold or category threshold was met. Criteria module 220 increments the surge counter by one for each incoming email received after the surge threshold was met. In some embodiments, criteria module 220 uses the one or more heuristics to classify incoming emails received after the surge threshold was met and may increment the surge counter by an amount associated with the met heuristic(s). Criteria module 220 may increment any category counters in the same way after any respective category thresholds have been met. This allows the criteria module 220 to weight incoming emails that include particular targeting characteristics higher than others. Criteria module 220 may monitor and increment the surge counter and any category counters until the associated threshold(s) are no longer met.

For an incoming email, criteria module 220 determines whether the incoming email meets one or more legitimacy criteria stored in monitor datastore 240. Each legitimacy criteria is associated with a trust characteristic, which is an attribute of an email that is indicative of the email being trustworthy (e.g., not spam). Examples of legitimacy criteria include whether the email came from a sender within domain 110 of user 111, a sender within a subsidiary domain of domain 110, or a sender who is a trusted third party, which user 111 or administrator 112 may indicate ahead of time. In some embodiments, each threshold is associated with its own set of legitimacy criteria that criteria module 220 monitors emails for.

In some embodiments, criteria module 220 classifies an incoming email to associate it with one or more clusters using a machine-learning model (e.g., a neural network). The criteria module 220 inputs attributes of an incoming email into the machine learning model and receives, as output from the machine learning model, a classification for the email along with an associated confidence score. The confidence score indicates the level of confidence for the prediction (e.g., expressed as a probability). Criteria module 220 extracts attributes from emails based on keywords, key phrases, and subject lines of emails. Similarly, criteria module 220 may extract attributes from metadata of emails, such as the time of sending the email. In some embodiments, extracted metadata describes information about the email relative to other emails, capturing events such as rapid succession of emails from the same sender during a sliding time frame. The machine-learning model may be trained to classify emails using a training dataset comprising labeled emails. During training, the classification(s) output by the machine-learning model are compared to the labeled training dataset to compute a loss score. Criteria module 220 then adjusts parameters of the machine-learning model (e.g., using backpropagation) based on the loss score. Criteria module 220 may then apply an optimization process (e.g., gradient descent) to update parameters of the machine-learning model.

Criteria module 220 clusters emails according to a set of labels. The machine-learning model labels each email with one or more labels. In some embodiments, the machine-learning model first clusters incoming emails according to a predetermined first set of labels (e.g., “surge event,” “non-surge event,” and “unknown”, where “surge event” indicates that an email is related to other emails that are part of a surge event, and “non-surge event” indicates that the email is not related to other emails that are part of the surge event). When a set of emails are clustered according to the set the labels, criteria module 220 may input a subset of the labeled emails to the machine-learning model to be clustered according to another set of labels. For example, the machine-learning model may receive the subset of emails labeled as “unknown” as input and classify them according to the second set of labels selected to assess sentiment (e.g., “positive,” “neutral,” and “negative”). As such, criteria module 220 may determine the nature of classification and level of scrutiny that a set of emails are subjected to, based on the configuration of the secure communications server 130. In some embodiments, emails are associated with multiple clusters. Alternatively, emails may be associated with only one cluster, such that the previous classification (e.g., “unknown”) is updated to reflect the next classification (e.g., “positive”).

In some embodiments, criteria module 220 determines that a subset of emails should be classified according to another set of labels based on the confidence score from the first classification. Upon predicting a label for an email with a low confidence score, the machine-learning model may associate the email with a label of the set of labels (e.g., “unknown”) according to a threshold value. Upon comparing the confidence score with the threshold value, criteria module 220 determines whether the email should be classified by the machine-learning model according to the other set of labels.

Criteria module 220 determines, using the machine-learning model, whether emails that are associated with the email overload should be subject to further review or assessment based on the confidence score. Emails may be subject to multiple levels of scrutiny according to a plurality of sets of labels. Each level may be associated with a confidence score range and a set of labels. For example, if the machine-learning model classifies an incoming email with a “surge event” label, criteria module 220 may send the email to the surge repository. As such, criteria module 220 positively identifies the email as being part of the email surge upon applying the machine learning model once.

In another example, the criteria module 220 applies the machine-learning model to an incoming email a first time to classify it as “unknown” and a second time to classify it as “negative.” As such, the email is sent to an appropriate inbox (e.g., a spam folder) after the second application of the machine-learning model. Removing a subset of emails received during the email overload from further passes through the machine-learning model reduces latency and computation requirements. Computational headroom afforded by clustering a given volume of emails allows for a greater volume of emails to be processed during an email overload.

In some embodiments, criteria module 220 clusters emails using an unsupervised machine-learning model. For example, the machine-learning model may be a k-means architecture (or any other clustering model such as nearest neighbor, etc.), in which a group of emails are clustered, where a hyperparameter defines the number of clusters. The machine-learning model receives a group of emails sent within the sliding time range as input and associates each email according to a plurality of unlabeled clusters. In some embodiments, criteria module 220 is configured to cluster emails into two clusters. Because emails that are a part of a surge event are generally expected to contain similar sentiment, criteria module 220 may associate incoming emails with one cluster or the other based on the semantic similarity of the incoming email with the group of emails in the cluster (e.g., the cluster of emails associated with the surge event). Responsive to an incoming email having semantic dissimilarity with the sentiment of the surge event, criteria module 220 may associate it with the other cluster. In some embodiments, multiple clusters may be associated with a surge. For example, a surge caused by a news anchor that relates to politics may receive surges of email from a political group that agrees and a political group that disagrees, and both of these email groups may be considered to be undesirable surge email, whereas other email may be part of one or more other clusters that are considered to be legitimate. In some embodiments, criteria module 220 determines that clusters that have a volume of email below a threshold satisfy a legitimacy criteria, and may determine that clusters exceeding or equaling the threshold do not.

In response to determining that an incoming email meets at least one legitimacy criteria, criteria module 220 causes the incoming email to be stored at user's 111 inbox repository, such that user 111 can view, respond to, or otherwise interact with the email via a user interface. In some embodiments, criteria module 220 determines that emails labeled as “non-surge event” by the machine-learning model meet a legitimacy criteria. As such, emails associated with the corresponding cluster are sent to the user's 111 inbox. In some embodiments, criteria module 220 only stores incoming emails that meet a threshold number of legitimacy criteria, which may be set by user 111 or administrator, in the inbox repository. User's 111 inbox repository may be at content management system 140 or secure communications service 130. In response to determining that an incoming email does not meet any legitimacy criteria, criteria module 220 stores the incoming email in the surge repository created for the surge. In some embodiments, criteria module 220 stores the identifier of and timestamp associated with the email in the surge repository instead of the full contents of the email to reduce processing power used by criteria module 220 during a surge.

Criteria module 220 stops monitoring for emails for the surge (e.g., signifying that the surge is over) in response to determining that a threshold amount of time has passed, the surge counter is below the surge threshold, a category counter is below a category threshold associated with the surge, and the like. Criteria module 220 may delete the surge repository after a threshold amount of time or in response to a request from user 111 or administrator 112. In some embodiments, criteria module 220 uses one or more heuristics or legitimacy criteria to check the emails in the surge repository during the surge or in response to the surge being over. By doing this, criteria module 220 may determine whether any emails where “false positives” (e.g., stored in the surge repository by mistake) or whether any emails have only a minor (e.g., less than a threshold) amount of targeting characteristics and move those emails to the inbox repository.

User interface module 230 generates user interfaces for display to users 111 and administrators 112 in the domain 110. User interface module 230 may generate an interface that allow users 111 and administrators 112 to view and otherwise interact with emails in their inbox repository and any surge repositories. In some embodiments, user interface module 230 also generates user interfaces that allow an administrator to turn on surge protection for user 111, which causes monitor module 210 to begin monitoring user's 111 emails. User interface module 230 may also generate user interfaces to alert administrator 112 that a surge repository was created for themselves or user 111 and alert user 111 or administrator 112 that a surge has begun or ended. Interactions may include releasing an email from the surge repository, which causes the user interface module 230 to move the email from the surge repository to a respective inbox repository, viewing heuristics that were met that resulted in criteria module 220 storing email in the surge repository, creating heuristics based on characteristics of emails within the surge repository, and the like.

In some embodiments, user interface module 230 may generate a summary of content of emails in the surge repository in response to a request via a user interface. User interface module 230 may create a prompt including the request and the emails within the surge repository. In some embodiments, user interface module 230 accesses the identifiers of emails stored in the surge repository and accesses the contents of the emails from a separate repository using the identifiers, such that user interface module 230 may include the contents in the prompt. User interface module 230 may input the prompt to generative language model 260. User interface module 230 may receive a summary from generative language model 260. For example, a summary may indicate that the emails represent a hate mail campaign. User interface module 230 may generate a user interface displaying the summary. In some embodiments, user interface module 230 generates the summary in response to determining that the surge repository includes more than a threshold number of emails. By waiting to generate the summary until the threshold number is reached, user interface module 230 may save processing power otherwise spent generating summaries before the surge has ended.

For administrator 112, user interface module 230 may include one or more interactive elements in the user interface that allow administrator 112 to view the emails, which enables administrator to device what next steps to take in response to the surge. Administrator 112 may interact with the user interface to turn on automatic remediation actions for the surge or any future surges, where such remediations actions may include alerting an information technology (IT) department about the surge. Administrators 112 may also send an indication to release the emails from the surge repository back to user's inbox repository or to stop moving emails into surge repository and reset the surge counter and any category counters.

In an example configuration, the datastore 240 of the communications service 130 contains subsets of data that are retrieved when actions of each module perform their functions. As such, actions performed by the communications service 130 at various states would include querying the datastore 240 and retrieving respective subsets of data. As states change and various actions are carried out across modules of the communications service 130, subsets of data may be retrieved from the datastore 240 multiple times. Such a configuration can introduce latency at each step of the workflow that impacts performance of the communications service 130.

In a preferred embodiment, transitions between states occur in a directional manner such that the output or result of a preceding state serves as input or trigger for the next state. As a pre-condition for advancing the workflow to the next state, the communications service 130 may determine that the preceding state has completed its actions and cannot be re-entered or queried until the next cycle of the workflow. The data or outcome produced by each state contains sufficient information for the subsequent state to perform its actions. As such, two or more states have a strict directional relationship, and the actions performed in a downstream state do not affect the completed behavior of an upstream state.

In some embodiments, one or more states of the secure communications service 130 transition according to a directed architecture, such as a state machine defined as a directed acyclic graph (DAG) or similar causal model. In this configuration, transitions occur in a directional manner such that the output or result of a preceding state serves as input or trigger for the next state. When the workflow advances to the next state, the communications service 130 may determine that the preceding state has completed its actions and cannot be re-entered or queried until the next cycle of the workflow. For example, actions performed by the criteria module 220 may not be performed until all upstream actions of the monitor module 210 are complete. The data or outcome produced by each state contains sufficient information for the subsequent state to perform its actions. As such, two or more states have a strict directional relationship, and the actions performed in a downstream state do not affect the completed behavior of an upstream state.

In some embodiments, where one or more states of the secure communications service 130 transition according to a strictly directed architecture, the sequential flow of state transitions reduces latency in the operation of the secure communications service 130. Once a state has completed its execution and transitioned forward, it cannot be queried or modified by later states. Therefore, the latency that would otherwise arise from backtracking or requesting additional input from a preceding state may be reduced. For example, a state responsible for monitoring message surges may output a “surge count” value. Once the system transitions to the next state, the next state uses the surge count as an input but is prohibited from querying or updating the earlier monitoring state to request changes to that value.

In addition to reducing latency, a secure communications service 130 configured with a strict directed state architecture may also benefit from reduced computational overhead during a workflow. In a system where the states have defined directional dependencies, any completed state does not perform further computation after its transition condition is met. Redundant computation across the workflow may be avoided if the directionality of the architecture enforces that earlier states are not to be queried or modified once their output is passed downstream. In some embodiments, the secure communications service 130 may represent its state machine as a DAG, where nodes correspond to states and directed edges represent valid transitions. The acyclic nature of the graph dictates that there are no circular transitions once the service progresses to a subsequent state. As such, earlier states are not re-entered within the same workflow.

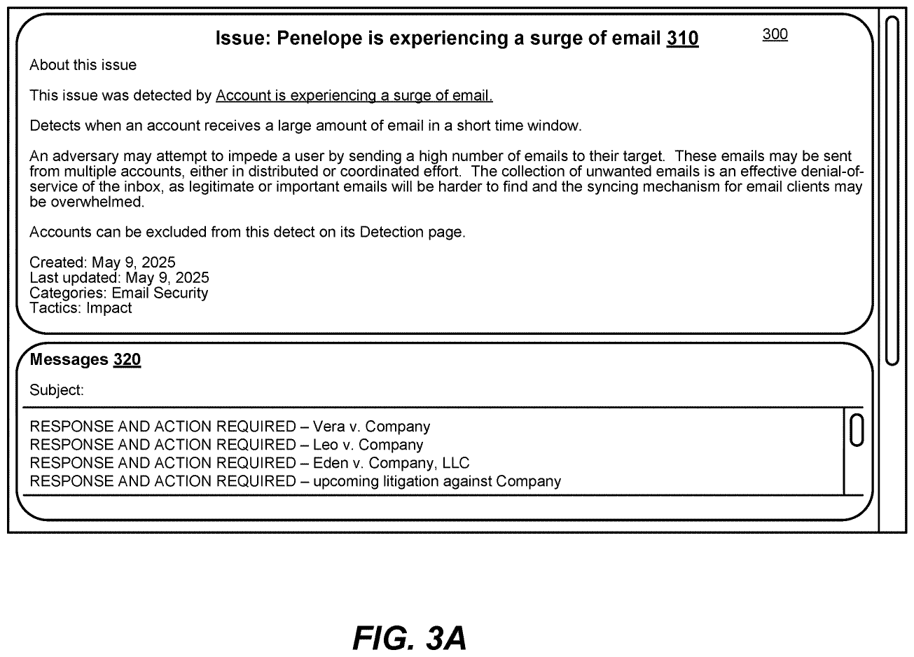

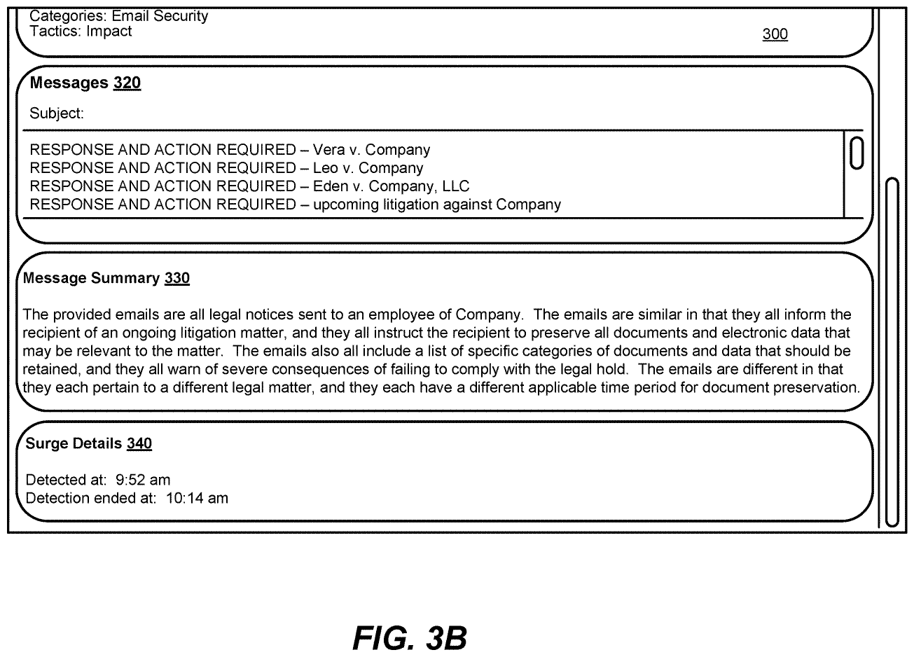

FIGS. 3A-3B illustrate an exemplary user interface 300 that display information about a surge of emails, in accordance with one or more embodiments. As depicted in FIG. 3A, user interface 300 includes an alert that a surge has occurred for Penelope (e.g., user 111). The alert includes information about why the surge may be occurring. User interface 300 also includes messages 320, which is a scrollable list of emails within the surge repository associated with the surge. As shown in subject lines of the emails, the emails detected for the surge pertain to a threat of litigation with “Company.” This is further described in the message summary 330 of FIG. 3B. The message summary 330 may have been generated by generative language model 260 and describes targeting characteristics that resulted in the emails being part of the surge. The targeting characteristics include litigation threats, instructions to preserve data, warnings of severe consequences for not complying, and being associated with the same entity (e.g., Company). The user interface 300 also includes surge details 340 that indicate when the surge was detected (e.g., the timestamp that the surge threshold or category threshold was met) and when the surge ended.

### Computing Machine Architecture

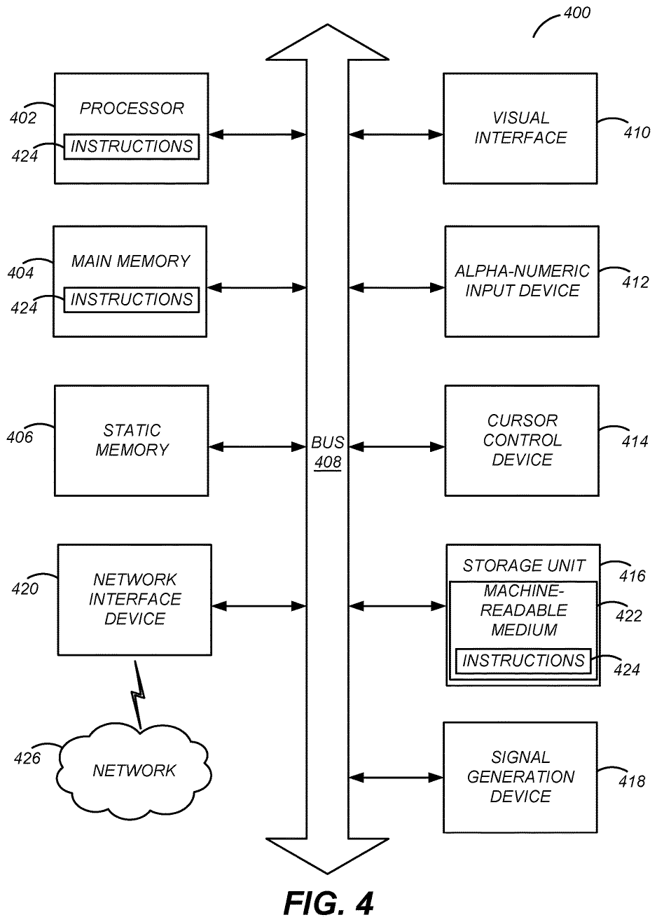

FIG. (Figure) 4 is a block diagram illustrating components of an example machine able to read instructions from a machine-readable medium and execute them in a processor (or controller, or one or more of the same). Specifically, FIG. 4 shows a diagrammatic representation of a machine in the example form of a computer system 400 within which program code (e.g., software, including the modules described herein) for causing the machine to perform any one or more of the methodologies discussed herein may be executed. The program code may be comprised of instructions 424 executable by one or more processors 402. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 424 (sequential or otherwise) that specify actions to be taken by that machine. Further, while only a single machine is illustrated, the term “machine” shall also be taken to include any collection of machines that individually or jointly execute instructions 424 to perform any one or more of the methodologies discussed herein.

The example computer system 400 includes a processor 402 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 404, and a static memory 406, which are configured to communicate with each other via a bus 408. The computer system 400 may further include visual display interface 410. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 410 may include or may interface with a touch enabled screen. The computer system 400 may also include alphanumeric input device 412 (e.g., a keyboard or touch screen keyboard), a cursor control device 414 (e.g., a mouse, a trackball, a joystick, a motion sensor, or other pointing instrument), a storage unit 416, a signal generation device 418 (e.g., a speaker), and a network interface device 420, which also are configured to communicate via the bus 408.

The storage unit 416 includes a machine-readable medium 422 on which is stored instructions 424 (e.g., software) embodying any one or more of the methodologies or functions described herein. The instructions 424 (e.g., software) may also reside, completely or at least partially, within the main memory 404 or within the processor 402 (e.g., within a processor's cache memory) during execution thereof by the computer system 400, the main memory 404 and the processor 402 also constituting machine-readable media. The instructions 424 (e.g., software) may be transmitted or received over a network 426 via the network interface device 420.

While machine-readable medium 422 is shown in an example embodiment to be a single medium, the term “machine-readable medium” should be taken to include a single medium or multiple media (e.g., a centralized or distributed database, or associated caches and servers) able to store instructions (e.g., instructions 424). The term “machine-readable medium” shall also be taken to include any medium that is capable of storing instructions (e.g., instructions 424) for execution by the machine and that cause the machine to perform any one or more of the methodologies disclosed herein. The term “machine-readable medium” includes, but not be limited to, data repositories in the form of solid-state memories, optical media, and magnetic media.

### Example Method

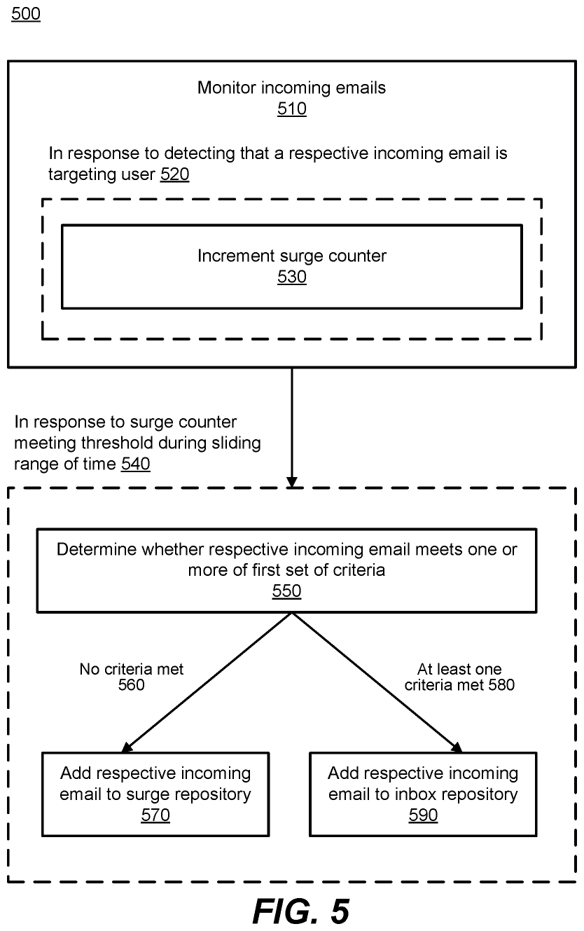

FIG. 5 is a flowchart of a method for determining whether to store an incoming email in a surge repository or an inbox repository, in accordance with one or more embodiments. In some embodiments, additional or alternative steps or components to those described may be used to perform the method 500. Further, the components described may be executed by the computer system 400 described in relation to FIG. 4.

The method 500 begins with monitoring 510 incoming emails to be stored, for a user 111, on content management system 140. The monitoring comprises monitor module 210 detecting whether each incoming email is targeting user 111. In response 520 to detecting that a respective incoming email is targeting the user, monitor module 210 increments 530 a surge counter. In response 540 to the surge counter meeting a first threshold during a sliding range of time, criteria module 220 determines 550, for each incoming email, whether the respective incoming email meets one or more of a first set of legitimacy criteria. In some embodiments, criteria module 220 also creates a surge repository in response to the surge counter meeting the first threshold. In response 560 to determining that the respective incoming email does not meet any of the first set of legitimacy criteria, the criteria module 220 adds 570 adds the respective incoming email to a surge repository associated with user 111. In response 580 to determining that the respective incoming email meets at least one of the first set of legitimacy criteria, criteria module 220 adds 590 the respective incoming email to an inbox repository associated with user 111.

In some embodiments, monitor module 210 determines whether each incoming email meets one or more heuristics and increments the surge counter in response to determining that the incoming email meets a heuristic. For example, monitor module 210 may perform a sentiment analysis on an incoming email by in inputting the incoming email to a machine learning model trained to compute a sentiment score for one or more input emails. The machine learning model may have been trained on emails manually labeled with sentiment scores by administrator 112 or determine the sentiment score based on a count of words in the email associated with one or more targeting characteristics (e.g., 100 words or 120 words out of 500 words). Monitor module 210 compares the sentiment score to a comprehensive score representative of sentiment of emails user's 111 inbox, which monitor module 210 may determine by inputting emails of user's 111 inbox repository into the machine learning model. In response to the sentiment score being at least a threshold amount different from the comprehensive score, monitor module 210 determines that the respective incoming email meets the heuristic associated with the sentiment analysis.

By detecting surges of emails as described herein, the secure communications service 130 may determine when an influx of emails that passed spam filter or otherwise look legitimate but are not have been sent in a condensed amount of time to a user. Movement of incoming emails into a surge repository may prevent a user's inbox from being overwhelmed with spam emails such that the user cannot find other emails while the surge is happening.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present), and B is false (or not present), A is false (or not present), and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for enforcing security in cloud-stored files for a domain through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for quarantining emails received during a surge of a plurality of emails, the method comprising:
monitoring incoming emails to be stored, for a user, on a content management system, wherein the monitoring comprises:
in response to detecting that a respective incoming email is targeting the user, incrementing a surge counter; and
storing an identifier of the respective incoming email in association with the surge counter;
in response to the surge counter meeting a first threshold during a sliding range of time:
adding the incoming emails with identifiers stored in association with the surge counter to a surge repository associated with the user;
determining, for each incoming email, whether the respective incoming email meets one or more of a set of legitimacy criteria;
in response to determining that the respective incoming email does not meet any of the set of legitimacy criteria, adding the respective incoming email to the surge repository; and
in response to determining that the respective incoming email meets at least one of the first set of legitimacy criteria, adding the respective incoming email to an inbox repository associated with the user.

2. The method of claim 1, the method further comprising:
in response to detecting that a respective incoming email is targeting the user, storing, in association with the surge counter, an identifiers of the respective incoming email, a timestamp of receipt of the respective incoming email, and an amount the surge counter was incremented by in response to detecting that the respective incoming email is targeting the user.

3. The method of claim 2, the method further comprising:
in response to determining that a timestamp stored in association with the surge counter is outside of the sliding time range:
accessing the identifier of the respective incoming email associated with the timestamp;
accessing the amount the surge counter was incremented by in response to detecting that the respective incoming email is targeting the user; and
reducing the surge counter by the accessed amount.

4. The method of claim 1, wherein the set of legitimacy criteria is associated with one or more trust characteristics.

5. The method of claim 1, the method further comprising:
determining, for each incoming email, whether the respective incoming email meets one or more of a set of heuristics, each heuristic associated with a targeting characteristic; and
in response to determining that the respective incoming email meets one or more heuristics, detecting that the respective incoming email is targeting the user; and
incrementing the surge counter by an amount associated with the one or more heuristics.

6. The method of claim 5, wherein determining, for each incoming email, whether the respective incoming email meets one or more of the set of heuristics comprises:
performing sentiment analysis on the respective incoming email by inputting the incoming email to a machine learning model trained to compute a sentiment score for one or more input emails;
comparing the sentiment score to a comprehensive score representative of sentiment of emails in an inbox associated with the user; and
in response to the sentiment score being at least a threshold amount different from the comprehensive score, determining that the respective incoming email meets a heuristic associated with the sentiment analysis.

7. The method of claim 5, wherein incrementing the surge counter by an amount associated with the one or more heuristics comprises:
determining a first amount associated with a first heuristic;
determining a second amount associated with a second heuristic, wherein the second amount is less than the first amount;
combining the first amount and second amount into a total amount; and
adding the total amount to the surge counter.

8. The method of claim 1, the method further comprising:
receiving, via a user interface, a request for a summary of content of the incoming emails in the surge repository;
inputting, to a generative language model, a first prompt, wherein the first prompt includes the incoming emails in the surge repository and the request;
receiving the summary from the generative language model; and
causing the user interface to present the summary.

9. The method of claim 1, the method further comprising:
presenting, via a user interface, incoming emails stored within the surge repository;
in response to receiving, via the user interface, a request to release an incoming email from the surge repository, moving the incoming email from the surge repository to the inbox repository.

10. The method of claim 1, further comprising:
in response to determining that the surge counter is below the surge threshold moving the incoming emails in the surge repository to the inbox;
storing new incoming emails in the inbox; and
deleting the surge repository.

11. The method of claim 1, wherein incoming emails are classified according to one or more clusters using a machine learning model, the clusters describing a degree of association between incoming emails and the surge of the plurality of emails.

12. The method of claim 1, wherein the operations of monitoring incoming emails to be stored are performed according to a directional acyclic graph (DAG), wherein nodes of the graph are associated with the operations and directed edges of the DAG are associated with directional flow of operation data between operations.

13. A non-transitory computer-readable storage medium storing instruction that, when executed, cause a processor to perform steps comprising:
monitoring incoming emails to be stored, for a user, on a content management system, wherein the monitoring comprises:
in response to detecting that a respective incoming email is targeting the user, incrementing a surge counter; and
storing an identifier of the respective incoming email in association with the surge counter;
in response to the surge counter meeting a first threshold during a sliding range of time:
adding the incoming emails with identifiers stored in association with the surge counter to a surge repository associated with the user;
determining, for each incoming email, whether the respective incoming email meets one or more of a set of legitimacy criteria;
in response to determining that the respective incoming email does not meet any of the set of legitimacy criteria, adding the respective incoming email to the surge repository; and
in response to determining that the respective incoming email meets at least one of the first set of legitimacy criteria, adding the respective incoming email to an inbox repository associated with the user.

14. The non-transitory computer-readable storage medium of claim 13, the steps further comprising:
in response to detecting that a respective incoming email is targeting the user, storing, in association with the surge counter, an identifiers of the respective incoming email, a timestamp of receipt of the respective incoming email, and an amount the surge counter was incremented by in response to detecting that the respective incoming email is targeting the user.

15. The non-transitory computer-readable storage medium of claim 14, the steps further comprising:
in response to determining that a timestamp stored in association with the surge counter is outside of the sliding time range:
accessing the identifier of the respective incoming email associated with the timestamp;
accessing the amount the surge counter was incremented by in response to detecting that the respective incoming email is targeting the user; and
reducing the surge counter by the accessed amount.

16. The non-transitory computer-readable storage medium of claim 13, wherein the set of legitimacy criteria is associated with one or more trust characteristics.

17. The non-transitory computer-readable storage medium of claim 13, the steps further comprising:
determining, for each incoming email, whether the respective incoming email meets one or more of a set of heuristics, each heuristic associated with a targeting characteristic; and
in response to determining that the respective incoming email meets one or more heuristics, detecting that the respective incoming email is targeting the user; and
incrementing the surge counter by an amount associated with the one or more heuristics.

18. The non-transitory computer-readable storage medium of claim 17, wherein determining, for each incoming email, whether the respective incoming email meets one or more of the set of heuristics comprises:
performing sentiment analysis on the respective incoming email by inputting the incoming email to a machine learning model trained to compute a sentiment score for one or more input emails;
comparing the sentiment score to a comprehensive score representative of sentiment of emails in an inbox associated with the user; and
in response to the sentiment score being at least a threshold amount different from the comprehensive score, determining that the respective incoming email meets a heuristic associated with the sentiment analysis.

19. The non-transitory computer-readable storage medium of claim 17, wherein incrementing the surge counter by an amount associated with the one or more heuristics comprises:
determining a first amount associated with a first heuristic;
determining a second amount associated with a second heuristic, wherein the second amount is less than the first amount;
combining the first amount and second amount into a total amount; and
adding the total amount to the surge counter.

20. A system comprising:
a processor; and
a non-transitory computer-readable storage medium storing instruction that, when executed, cause a processor to perform steps comprising:
monitoring incoming emails to be stored, for a user, on a content management system, wherein the monitoring comprises:
in response to detecting that a respective incoming email is targeting the user, incrementing a surge counter; and
storing an identifier of the respective incoming email in association with the surge counter;
in response to the surge counter meeting a first threshold during a sliding range of time:
adding the incoming emails with identifiers stored in association with the surge counter to a surge repository associated with the user;
determining, for each incoming email, whether the respective incoming email meets one or more of a set of legitimacy criteria;
in response to determining that the respective incoming email does not meet any of the set of legitimacy criteria, adding the respective incoming email to the surge repository; and
in response to determining that the respective incoming email meets at least one of the first set of legitimacy criteria, adding the respective incoming email to an inbox repository associated with the user.
